(19) United States
(12) Patent Application Publication
(10) Pub. No.: US 2006/0187914 A1
(43) Pub. Date: Aug. 24, 2006

(54) Method and device for managing heterogeneous communication networks

(75) Inventors: Ashwin Anil Gumaste, Dallas, TX (US); Susumu Kinoshita, Plano, TX (US)

Correspondence Address: BAKER BOTTS L.L.P., 2001 ROSS AVENUE, SUITE 600, DALLAS, TX, 75201-2980, US

(73) Assignee: Fujitsu Limited

(21) Appl. No.: 11/060,865

(22) Filed: Feb. 18, 2005

(51) Int. Cl. H04L 12/28

(52) U.S. Cl. 370/389; 370/402

(57) ABSTRACT

A communication system includes in-band networks, out-of-band (OOB) networks, and translating nodes. In-band data is communicated in the in-band networks in a shared channel and routed based on a destination address specified by in-band control information that is also communicated in the same shared channel as the data. OOB data is communicated in the OOB networks in an OOB data channel and routed based on control information communicated in an OOB control channel, the OOB control channel being a different channel from the OOB data channel on which the OOB data is transmitted. Translating nodes couple the OOB networks and in-band networks and are capable of translating in-band control data and in-band control information for communication in the OOB networks. The translating nodes are also capable of translating OOB control information and OOB data for communication in the in-band networks.

### TECHNICAL FIELD

The present invention relates generally to optical networks and, more particularly, to a method and device for managing heterogeneous communication networks.

### BACKGROUND

Telecommunication systems, cable television systems, and data communication networks use optical networks to rapidly convey large amounts of information between remote points. In an optical network, information is conveyed in the form of optical signals through optical fibers. Optical fibers comprise thin strands of glass capable of transmitting optical signals over long distances with very low loss of signal strength.

Recent years have seen an explosion in the use of telecommunication services. Piecemeal expansion of global optical networking infrastructure has resulted in a patchwork collection of networks that utilize many different protocols and communication standards. As a result, integration issues have become a major consideration in the development of optical hardware for use in these systems.

### SUMMARY

The present invention provides a heterogeneous communication system that includes components operable to support transmission of data between networks using differing control.

According to a particular embodiment of the present invention, a communication system, includes one or more in-band networks, one or more out-of-band (OOB) networks, a first translating node, and a second translating node. The in-band networks are each capable of communicating data generated by a plurality of devices coupled to that in-band network. The data is communicated in the in-band networks in a channel and routed based on a destination address specified by in-band control information that is also communicated in the same channel as the data. The out-of-band networks are capable of communicating data between a plurality of translating nodes based on OOB control information that is associated with the data and that is communicated on an OOB control channel, wherein the OBB control channel comprises a different channel from the data channel on which the data is transmitted.

The first translating node couples the OOB network and a first in-band network and is capable of receiving data and control information from the in-band network coupled to the first translating node. The first translating node is further capable of identifying, based on the control information, a second translating node associated with the destination address of the data. This second translating node couples the OOB network and a second in-band network with which the destination address is associated. The first translating node is also capable of transmitting the control information to the second translating node in the control channel of the OOB network and transmitting the data to the second translating node on the data channel of the OOB network.

The second translating node couples the OOB network and a second in-band network and is capable of receiving the control information from the first translating node on the OOB control channel of the OOB network and receiving the data from the first translating on the data channel of the OOB network. The second translating node is also capable of determining based on the control information that the data is destined for a device coupled to the second in-band network and combining the data and at least a portion of the control information. The second translating node may then transmit the combined data and control information to the destination in the second in-band network.

Technical advantages of certain embodiments of the present invention may include the ability to support end-to-end communication of optical traffic traversing a heterogeneous collection of communication networks. Other technical advantages may include providing a low-cost alternative to Layer-3 routers to facilitate communication between networks using different control techniques and the ability to dynamically update address information across multiple heterogeneous networks.

It will be understood that the various embodiments of the present invention may include some, all, or none of the enumerated technical advantages. In addition other technical advantages of the present invention may be readily apparent to one skilled in the art from the figures, description, and claims included herein.

### BRIEF DESCRIPTION OF THE DRAWINGS

FIG. 1 illustrates a heterogeneous communication system in accordance with one embodiment of the present invention;

FIG. 2 illustrates contents and example operation of particular embodiment of translating nodes that may be utilized in the optical network shown in FIG. 1;

FIG. 3 further illustrates example operation of the translating nodes shown in FIG. 2; and

FIG. 4 is a flowchart illustrating an example operation of the heterogeneous communication system shown in FIG. 1 while communicating traffic between two devices located on different in-band networks.

### DETAILED DESCRIPTION OF THE DRAWINGS

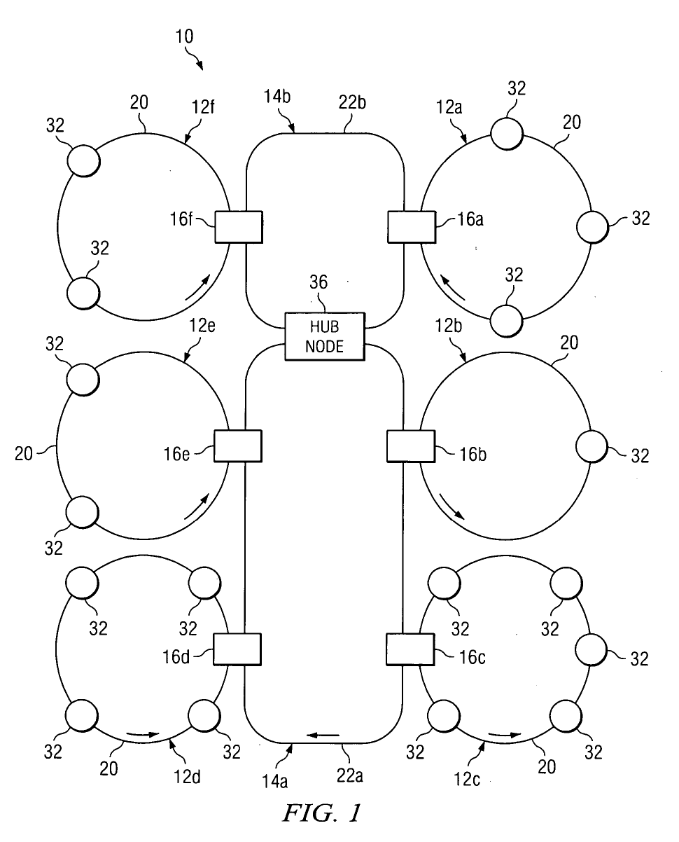

FIG. 1 illustrates a heterogeneous communication system 10 in accordance with one embodiment of the present invention. Heterogeneous communication system 10 comprises a plurality of networks including one or more in-band networks 12 and one or more out-of-band (OOB) networks 14. In in-band networks 12, control information is transmitted in the same channel as its associated data while, in OOB networks 14, control information is transmitted on a separate channel from its associated data. Translating nodes 16 communicate control information between in-band networks 12 and OOB networks 14 to allow data transmitted on one type of network to traverse or to be delivered to devices on another type of network. As a result, in particular embodiments of heterogeneous communication system 10, each translating node 16 is capable of receiving ingress traffic on an in-band network 12 and/or an OOB network 14 and translating the ingress traffic for transmission as egress traffic on a network of the opposite type.

Heterogeneous communication system 10 may include any suitable types of in-band networks 12 and OOB networks 14 configured to provide the described functionality. Although the description below focuses on an embodiment of heterogeneous communication system 10 configured to support the communication of optical traffic, particular embodiments of communication system 10 may be configured to support communication in any appropriate form. For the purposes of this description and the claims that follow, “traffic” means any information transmitted, stored, or sorted in the network. Such traffic may comprise signals having at least one characteristic modulated to encode data, audio, video, textual, real-time, non-real-time and/or other suitable information. Although, as shown, heterogeneous communication system 10 includes two OOB network 14 that is coupled to each of a plurality of in-band networks 12, particular embodiments of heterogeneous communication system 10 may include any number of OOB networks 14 and in-band networks 12 configured in any appropriate manner. In the illustrated example, in-band networks 12 couple to OOB networks 14a and 14b through translating nodes 16, while OOB networks 14a and 14b couple to one another through hub node 36.

In-band networks 12 facilitate the communication of optical traffic to and from in-band nodes 32. As indicated above, in-band networks 12 comprise optical networks that, at least in part, utilize in-band control information to route, sort, and/or otherwise process data transmitted on in-band networks 12. As used in this description and the claims that follow, “in-band” control information may include any information that describes how an associated element of data is to be routed, sorted, and/or otherwise processed and that is transmitted on the same channel as the associated data on heterogeneous communication system 10. By contrast, “out-of-band” control information may include any such information that is transmitted on a different channel from an associated element of data. Transmission on a different channel, for purposes of this description, may represent transmission of the control information on a different wavelength from the wavelength used to transmit associated data or on a physically separate fiber or other transmission media.

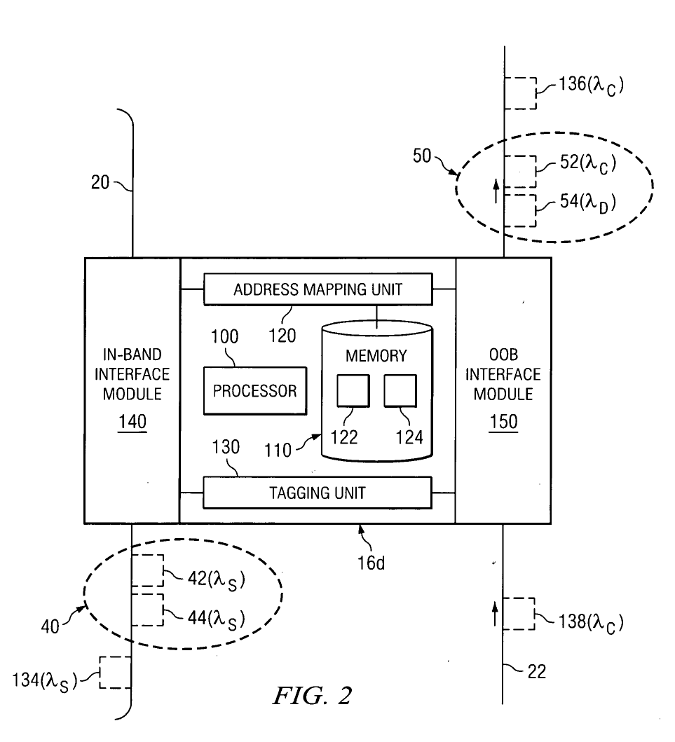

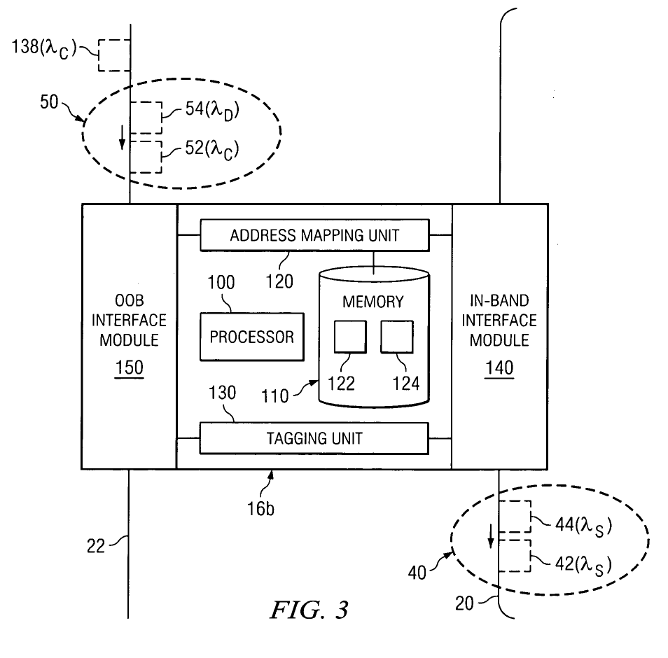

In the illustrated embodiment, in-band networks 12 each include an in-band optical ring 20 for propagating optical traffic between components of that in-band network 12. Although FIG. 1 illustrates in-band networks 12 that have a ring configuration, heterogeneous communication system 10 may include in-band networks 12 that have any appropriate configuration. Additionally, for the purposes of simplicity, FIGS. 2 and 3 illustrate traffic propagating on in-band optical rings in only a single direction on each optical ring 20. Nonetheless, in particular embodiments of in-band networks 12, traffic may propagate in either or both directions on in-band optical ring 20, as appropriate based on the configuration of that in-band network 12. Moreover, in-band optical rings 20 may each comprise a single, unidirectional fiber, a single, bi-directional fiber, or a plurality of uni- or bi-directional fibers. Additionally, in-band networks 12 may represent optical networks in which a number of optical channels are carried over a common path in disparate wavelengths/channels. For example, in-band networks 12 may be wavelength division multiplexing (WDM), dense wavelength division multiplexing (DWDM), or other suitable multi-channel networks.

OOB network 14 facilitates communication of optical traffic to and from translating nodes 16. OOB network 14 comprises optical networks that, at least in part, utilize out-of-band control information to route, sort, and/or otherwise process data transmitted on OOB network 14. As noted above, “out-of-band” control information may include any information that describes how an associated element of data is to be routed, sorted, and/or otherwise processed and that is transmitted in a different channel from the associated data. In the illustrated embodiment, OOB networks 14 each include an OOB optical ring 22 for propagating optical traffic between components of that OOB network 14. As with in-band networks 12, this optical ring may comprise a single, unidirectional fiber, a single, bi-directional fiber, or a plurality of uni- or bi-directional fibers. Optical ring 22 communicates information on at least two channels, an OOB control channel and an OOB data channel. Moreover, as noted above, the OOB control channel and the OOB data channel may represent separate wavelengths supported by a single fiber or separate fibers each supporting communication of control information or data, respectively. For the purposes of simplicity, FIGS. 2 and 3 illustrate traffic propagating on OOB optical rings 22 in only a single direction on each optical ring 22. Nonetheless, in particular embodiments of in-band networks 12, traffic may propagate in either or both directions on in-band optical ring 20, as appropriate based on the configuration of that in-band network 12.

Additionally, although the description below focuses on an embodiment of OOB network 14 that utilizes only a single OOB control channel and a single OOB data channel, particular embodiments of OOB network 14 may be configured to utilize multiple OOB control channels and multiple OOB data channels. Furthermore, as noted above, a particular OOB control channel and OOB data channel may be supported on a single fiber as distinctly different wavelengths or on separate fibers. In a particular embodiment, OOB network 14 represents a metro-area network (MAN) in which a number of optical channels are carried over a common path in disparate wavelengths/channels.

Translating nodes 16 translate optical traffic propagating between in-bound networks 12 and OOB networks 14. In particular, translating nodes 16 translate control information transmitted on in-band networks 12, referred to here as “in-band control information,” to facilitate delivery of data associated with the OOB control information, referred to here as “in-band data,” to components on OOB network 14 or to components on other in-band networks 12 through OOB network 14. Similarly, translating nodes 16 also translate control information transmitted on OOB network 14, referred to here as “OOB control information,” to facilitate delivery of associated data, referred to here as “OOB data,” on a particular in-band network 12. Translating nodes 16 may represent any combination of hardware and/or software suitable to provide the described functionality. The contents and operation of particular embodiments of translating node 16 are described in greater detail with respect to FIGS. 2 and 3.

In-band nodes 32, in the illustrated embodiment, add traffic to and drop traffic from optical rings 20 of in-band networks 12 to support communication to and from these in-band nodes 32 or other devices coupled to in-band nodes 32. For example, in-band nodes 32 may receive electrical traffic from client devices coupled to those in-band nodes 32 and generate optical traffic based on this electrical traffic. In-band nodes 32 may then add this traffic to the optical ring 20 of the in-band network 12 to which that in-band node 32 is coupled. In particular, in-band nodes 32 generate optical traffic that includes data and control information to be used to route, sort, and/or otherwise process this data. Moreover, in-band nodes 32 are configured to transmit this data and the associated control information in the same channel, referred to here as a “shared channel,” on optical ring 20.

Each in-band node 32 may also receive traffic from the optical ring 20 destined for that in-band node 32 or devices coupled to that in-band node 32. For example, in a particular embodiment, in-band nodes 32 may receive optical traffic from optical ring 20 and drop optical traffic destined for client devices coupled to in-band nodes 32. For the purposes of this description, nodes may “drop” traffic by transmitting a copy of the traffic to any appropriate components coupled to the relevant node. As a result, in-band nodes 32 may drop traffic from in-band networks 12 by transmitting the traffic to components coupled to that in-band node 32 while allowing the traffic to continue to downstream components on optical ring 20. Although the description below focuses, for purposes of simplicity, on an embodiment of heterogeneous communication system 10 in which nodes 32 are configured to support communication to and from client devices coupled to in-band nodes 32, in-band nodes 32 may additionally or instead support communication to and from external networks coupled to in-band nodes 32, to and from in-band nodes 32 themselves, or to and from any other elements of heterogeneous communication system 10 coupled to in-band nodes 32. Furthermore, in-band nodes 32 may comprises any suitable collection of software and/or hardware, including any appropriately configured transmitters, receivers, couplers, and/or other components appropriate to provide the described functionality.

Hub node 36 couples multiple OOB networks 14 and may switch, route, or otherwise direct the flow of OOB traffic to facilitate communication between elements in or coupled to different OOB networks 14. For example, hub node 36 may, based on control information received by hub node 36, direct traffic received on optical ring 22a of OOB network 14a to optical ring 22b of OOB network 14b to facilitate the delivery of traffic from a source component located in or coupled to OOB network 14a to a destination component located in OOB network 14b. Hub node 36 may, as appropriate, direct the flow of any or all of the OOB control information, OOB data, and remote address updates described below. Additionally, hub node 36 may comprise any suitable collection of software and/or hardware, including any appropriately configured transmitters, receivers, couplers, and/or other components appropriate to provide the described functionality.

Additionally, although not explicitly shown in FIG. 1, OOB networks 14 may include one or more out-of-band (OOB) nodes that add traffic to and drop traffic from the optical ring 22 of the associated OOB network 14 to facilitate communication to and from these OOB nodes or other devices coupled to the OOB nodes. As with in-band nodes 32, OOB nodes may drop traffic from OOB networks 14 by transmitting the traffic to components coupled to that OOB node while allowing the traffic to continue to downstream components on OOB networks 14. If included in OOB networks 14, these OOB nodes may comprise any suitable collection of software and/or hardware, including any appropriately configured transmitters, receivers, couplers, and/or other components appropriate to provide the described functionality.

In operation, in-band nodes 32 generate optical traffic that is transmitted on in-band networks 12. In a particular embodiment of heterogeneous communication system 10, in-band nodes 32 generate optical traffic based on electrical traffic received by these nodes from client devices (not shown) coupled to these nodes. Additionally, these in-band nodes 32 receive and process optical traffic received on their associated in-band network 12 and transmit appropriate portions of this traffic to client devices coupled to the in-band nodes 32.

In particular, in-band nodes 32 generate in-band traffic 40 that includes both in-band control information 42 and in-band data 44. In the illustrated embodiment, in-band data 44 may represent any suitable data to be transmitted on heterogeneous communication system 10. In-band control information 42 comprises any appropriate information transmitted along with the data and indicating how the associated in-band data 44 is to be routed, sorted, and/or otherwise processed. For example, in a particular embodiment, in-band nodes 32 transmit optical traffic in the form of Ethernet frames. In such an embodiment, in-band data 44 may represent data portions of Ethernet frames and in-band control information 42 may represent headers and/or other addressing information associated with these Ethernet frames. As noted above, in-band nodes 32 transmit in-band data 44 and the associated in-band control information 42 on the same channel.

To allow in-band traffic 44 that is transmitted on a particular in-band network 12, for example in-band network 12b, to be transmitted to other in-band networks 12 through OOB network 14, translating nodes 16 facilitate the translation of in-band control information 42 to OOB control information 52. More specifically, optical traffic may be transmitted by a particular in-band node 32 on in-band network 12b and transmitted to the translating node 16b that couples in-band network 12b to OOB network 14. The relevant translating node 16 may then extract in-band control information 42 and in-band data 44 from the in-band traffic 40 and transmit each on separate channels in OOB network 14.

More specifically, translating node 16b may extract in-band control information 42 from in-band traffic 40. This in-band control information 42 may identify a destination node for in-band data 44. If this destination node is located on another in-band network 12, translating node 16b may determine a translating node 16 that couples that in-band network 12 to OOB network 14. Translating node 16 may transmit OOB control information 52 to the destination translating node 16, the OOB control information 52 identifying the device on the destination in-band network 12d that represents the destination of in-band data 44. Translating node 16 then transmits OOB data 54 to the destination translating node 16. If appropriate, hub node 36 may switch OOB control information 52 and OOB data 54 for delivery to a destination translating node 16 on a different OOB network 14a or 14b and/or take any other appropriate steps to effect delivery of OOB data 54 to the appropriate translating node 16. FIG. 2 illustrates in greater detail the operation of a particular embodiment of translating node 16 in completing this process.

Similarly, to allow OOB traffic 50 that is transmitted on OOB network 14 to be delivered to a particular device on a particular in-band network 12 translating nodes 16 may facilitate the translation of OOB control information 52 to in-band control information 42. More specifically, once OOB data 54 reaches the destination translating node 16, for example translating node 16b, translating node 16b determines based on the associated OOB control information 52 transmitted to it by a source translating node 16, that the relevant OOB data 54 is destined for an in-band node 32 or other device located on band network 12b. Translating node 16b may then process the data and the associated OOB control information 52, which are received on separate channels of OOB network 14, to form in-band traffic 40. Translating node 16b may then transmit in-band traffic 40 on a single channel of in-band network 12e for delivery to the destination device.

Thus, heterogeneous communication system 10 provides certain techniques for effectively managing heterogeneous optical networks. As a result, optical communication system 10 may support end-to-end communication across multiple types of networks. Moreover, because translating nodes 16 may replace relatively expensive and less efficient Layer-3 routers that may be used in other communication systems to couple in-band networks to out-of-band networks, translating nodes 16 may offer a cost-effective solution for integrating heterogeneous communication systems. As a result, particular embodiments of heterogeneous communication system 10 and/or various components of heterogeneous communication system 10 may provide a number of benefits.

FIG. 2 illustrates the contents of a particular embodiment of a translating node 16 and the operation of this embodiment in translating in-band traffic 40 for transmission on OOB network 14. In particular, FIG. 2 illustrates operation of translating node 16d as translating node 16d transmits OOB traffic 50 to another translating node 16, referred to here as “destination translating node 16”, for delivery to a device on the in-band network 12 associated with destination translating node 16. Translating node 16d converts in-band control information 42 to OOB control information 52 so that in-band traffic 40 received from a particular in-band network 12 that is coupled to translating node 16d (here in-band network 12d) can be transmitted on OOB network 14. As shown, translating node 16d includes an address mapping unit 120, a tagging unit 130, a processor 100, and a memory 110. Additionally, translating node 16d couples to in-band network 12d through an in-band interface module 140 and couples to OOB network 14 through an OOB interface module 150.

Processor 100 executes programmed instructions and performs appropriate calculations, determinations, and/or other processing tasks associated with the functions of translating node 16d. Processor 100 may be a general purpose computer, dedicated microprocessor, or other processing device capable of communicating electronic information. Examples of processor 100 include application-specific integrated circuits (ASICs), field-programmable gate arrays (FPGAs), digital signal processors (DSPs) and any other suitable specific- or general-purpose processors.

Memory 110 stores programmed instructions, network addresses, buffered traffic, and/or any other appropriate data or information associated with the operation of translating node 16d or heterogeneous communication system 10. Memory 110 may comprise any collection and arrangement of volatile or non-volatile, local or remote devices suitable for storing data, such as for example random access memory (RAM) devices, read only memory (ROM) devices, magnetic storage devices, optical storage devices, or any other suitable data storage devices.

Address mapping unit 120 identifies the location of devices associated with OOB traffic 50 and in-band traffic 40 received by translating node 16d. Address mapping unit 120 may maintain any appropriate information to allow address mapping unit 120 to determine an appropriate destination to which to route OOB traffic 50 and in-band traffic 40 including, as described in greater detail below, a local address list 122 and a remote address list 124. Address mapping unit 120 may use local address list 122 and remote address list 124 to determine appropriate destinations for traffic received from in-band network 12d and OOB network 14. Address mapping unit 120 may comprise any suitable combination of hardware and/or software appropriate to provide the described functionality. In particular embodiments, address mapping unit 120 represents, at least in part, a computer application running on processor 100.

Tagging unit 130 removes in-band control information 42 from in-band traffic 40 received by translating node 16d and adds OOB control information 52 to OOB traffic 50 received by translating node 16d. Tagging unit 130 may include any suitable combination of hardware and/or software appropriate to provide the described functionality. In particular embodiments, tagging unit 130 represents, at least in part, a computer application running on processor 100.

In-band interface module 140 receives in-band traffic 40 from in-band network 12d and transmits in-band traffic 40 to in-band network 12d while OOB interface module 150 receives OOB traffic 50 from OOB network 14a and transmits OOB traffic 50 to OOB network 14a. In particular, in-band interface module 140 interfaces translating node 16d with a shared channel of optical ring 20, while OOB interface module 150 interfaces translating node 16d with the OOB data channel and the OOB control channel of. In a particular embodiment, in-band interface module 140 and OOB interface module 150 represent, in part, a computer application running on processor 100. In these and other embodiments, in-band interface module 140 and OOB interface module 150 may also include an appropriate collection of hardware to transmit and receive in-band traffic 40 and OOB traffic 50 on in-band network 12 and OOB network 14, respectively. In general, however, in-band interface module 140 and OOB interface module 150 may represent any suitable physical layer interface to the associated networks.

At startup or at any other appropriate time, translating node 16d may receive addressing information from client devices located in heterogeneous communication system 10 and may store the addressing information for later use in routing traffic received on in-band network 12d and OOB network 14. This addressing information may identify in any appropriate manner the location of the associated client devices. In particular embodiments, translating node 16d maintains local address list 122 and remote address list 124.

Local address list 122 includes physical addresses, such as a Layer-2 address, associated with client devices that are coupled to heterogeneous communication system 10 through in-band network 12d. During or prior to operation, translating node 16d may receive local address updates 134 from in-band nodes 32 through in-band interface module 140 informing translating node 16d of changes to the collection of in-band nodes currently connected to in-band network 12d. Although, in the illustrated embodiment, in-band nodes 32 transmit local address updates 134 on the same channel, λ_{S}, on which in-band data and control information are transmitted, in-band nodes 32 may in general transmit local address updates 134 on any appropriate channel supported by the relevant in-band network 12. Upon receiving a local address update 134, in-band interface module 140 may forward local address updates 134 to address mapping unit 120, and address mapping unit 120 may use the local address updates 134 to create a new local address list 122 or update an existing local address list 122.

Local address updates 134 may represent signal pulses, packets, frames, messages, or information structured in any other suitable format. Moreover, local address updates 134 include any information suitable to inform translating node 16d of newly-added or removed client devices in in-band network 12d. For example, in particular embodiments, a client device may transmit a registration message specifying an address of the client device to translating node 16d when the client device connects to in-band network 12d. Similarly, in particular embodiments, when the client device disconnects from in-band network 12d, the client device may also transmit a disconnect message specifying the address of the client device to translating node 16d. Additionally, address mapping unit 120 may, in response to receiving local address updates 134, generate remote address updates 138, as described below, for transmission to other translating nodes 16. As a result, other translating nodes 16 may be able to maintain updated information pertaining to client devices currently in in-band network 12d.

Remote address list 124 includes physical addresses associated with client devices that couple to heterogeneous communication system 10 through in-band networks 12 other than in-band network 12d. In particular embodiments, remote address list 124 comprises one or more remote address pairs that each include a physical address of a client device, such as a Layer-2 address, and the address of the translating node 12 that couples the in-band network 12 in-which the relevant client device is located to OOB network 14a or 14b. Furthermore, translating node 16d may receive remote address updates 138 that inform translating node 16d of changes to the collection of in-band nodes currently connected to in-band networks 12 other than in-band network 12d. More specifically, OOB interface module 150 of translating node 16d may receive remote address updates 138 from client devices currently or previously coupled to in-band networks 12 other than in-band network 12d. OOB interface module 150 may forward these remote address updates 138 to address mapping unit 120, and address mapping unit 120 may use the remote address updates 138 to create a new remote address list 124 or update an existing remote address list 124.

Remote address updates 138 may represent one or more signal pulses, packets, frames, messages, or information structured in any other suitable format. Moreover, remote address updates 138 include any information suitable to inform translating node 16d of newly-added or removed client devices in other in-band networks 12. Translating nodes 16 may generate remote address updates 138 when client devices are added or subtracted from their associated in-band network 12, when requested by other translating nodes 16, and/or at any other appropriate time. For example, when a client device connects or disconnects to a particular in-band network 12, the associated translating node 16 may forward the registration message or disconnect message sent by that client device to other translating nodes 16 in optical communication system 10. Although, in the illustrated embodiment, remote address updates 138 are transmitted and received by translating nodes 16 on the same channel, λ_{C}, on which OOB control information is transmitted, translating nodes 16 may in general transmit and receive remote address updates 138 on any appropriate channel supported by the relevant OOB network 14.

Translating node 16d may then utilize addressing information stored in local address list 122 and remote address list 124 to facilitate communication between components coupled to in-band network 12d and components coupled to other in-band networks 12 and/or OOB networks 14. For example, during operation, translating node 16d may receive in-band traffic 40 through in-band interface module 140. In-band traffic 40 includes in-band data 44 destined for a particular element of heterogeneous communication system 10 and in-band control information 42. As noted above, translating node 16d receives in-band data 44 and in-band control information 42 on a shared channel. This shared channel may represent one of one or more channels supported by in-band network 12d. Additionally, depending on the configuration of in-band network 12d, each of the plurality of shared channels may represent a single wavelength among multiple wavelengths utilized by in-band network 12d or may represent a single fiber among multiple fibers utilized by in-band network 12d. In the illustrated embodiment, the shared channel represents a wavelength λ_{S} used for the transmission of both in-band data 44 and in-band control information 42.

As also noted above, in-band traffic 40 may comprise a plurality of packets, each including all or a portion of in-band data 44 and all or a portion of in-band control information 42. For example, in particular embodiments, in-band traffic 40 comprises a plurality of Ethernet packets, each carrying in-band data 44 and in-band control information 42. In such embodiments, in-band control information 42 may represent headers of these plurality of Ethernet frames that include a destination address for the Ethernet frames.

In-band interface module 140 may forward a copy of in-band traffic 40 to both tagging unit 130 and address mapping unit 120. In alternative embodiments, in-band interface module 140 may extract in-band control information 42 and in-band data 44 from in-band traffic 40. In such embodiments, in-band interface module 140 may subsequently transmit in-band control information 42 and in-band data 44 to address mapping unit 120 and tagging unit 130, respectively.

Address mapping unit 120 receives in-band control information 42 and attempts to identify, based on both the contents of in-band control information 42 and remote address list 124, a translating node 16 associated with the destination of in-band data 44. As noted above, remote address list 124 includes one or more remote address pairs, each remote address pair comprising an address for a client device connected to an in-band network 12 other than in-band network 12d and an address for the translating node 16 that coupled the other in-band network 12 to OOB network 14a or 14b. Address mapping unit 120 attempts to identify the particular translating node 16 (referred to here as “destination translating node 16”) that serves as a gateway to the in-band network 12 (referred to here as “destination network 12”) in which the destination of in-band data 44 is located. Address mapping unit 120 may attempt to identify the destination translating node 16 by matching the physical address of the destination client device to the client device address of a remote address pair in remote address list 124. If one of the remote address pairs includes the address of the destination client device, then address mapping unit 120 identifies the associated translating node address of that remote address pair as the destination translating node 16 for in-band data 44.

If remote address list 124 does not include a remote address pair with a client device address that matches the destination of in-band data 44, address mapping unit 120 may request information from other elements of heterogeneous communication system 10 to facilitate routing of in-band data 44. For example, in particular embodiments of heterogeneous communication system 10, address mapping unit 120 may generate an address request message 136 that specifies the physical address of the destination device. Translating node 16d may then transmit address request message 136 to appropriate elements of heterogeneous communication system 10 on the OOB control channel, here λ_{C}, using OOB interface module 150. In a particular embodiment, translating node 16d broadcasts address request message 136 to all other translating nodes 16 on OOB networks 14 (including those translating nodes 16 coupled to OOB network 14b). In response to address request message 136, one or more translating nodes 16 may transmit a remote address update 138 on the OOB control channel to translating node 16d that provides additional addressing information to translating node 16d. For example, an appropriate translating node 16 may transmit to the requesting translating node 16d a remote address update 138 that specifies an address or other identifying information identifying itself as the destination translating node 16 associated with the destination device.

After identifying destination translating node 16, whether based on information stored in remote address list 124 or received in a remote address update 138, address mapping unit 120 generates OOB control information 52 that identifies destination translating node 16. In particular embodiments, OOB control information 52 includes some or all of in-band control information 42. Translating node 16d may then transmit OOB control information 52 to the destination translating node 16 on the OOB control channel through OOB interface module 150. If appropriate, hub node 36 may switch, route, forward, or otherwise direct OOB control information 52 on to optical ring 22b to facilitate the delivery of OOB control information 52 to a destination translating node 16d in OOB network 14b. The destination translating node 16, or other appropriate components of the destination in-band network 12, may then use control information 52 to switch, route, forward, or otherwise direct the OOB data 54 (after OOB data 54 has been converted to in-band data for transmission on that in-band network 12) to the destination device on that in-band network 12.

Meanwhile, in particular embodiments, tagging unit 130 also receives a copy of in-band traffic 40 and/or in-band data 44. If appropriate, tagging unit 130 removes in-band control information 42 from in-band traffic 40 and/or otherwise extracts in-band data 44. Tagging unit 130 then generates OOB data 54 based on in-band data 44. Tagging unit 130 may use any appropriate techniques to remove in-band control information 42, extract in-band data 44, and/or generate OOB data 54, based on the format of in-band traffic 40 and the configuration of optical configuration system 10. In a particular embodiment, in-band traffic 40 represents Ethernet frames, and tagging unit 130 removes and discards the header from the Ethernet frames to form OOB data 54.

Translating node 16d then transmits OOB data 54 to the destination translating node 16 on the OOB data channel through OOB interface module 150. Translating node 16d may transmit OOB data 54 prior to, concurrently with, or subsequent to transmitting the associated OOB control information 52. Moreover, translating node 16d may use conventional out-of-band signaling methods or any other suitable techniques to associate OOB data 54 with the appropriate OOB control information 52. For example, before transmitting OOB data 54, translating node 16d may transmits a setup message that includes OOB control information 52 to the destination translating node 16 alerting the destination translating node 16 to the fact that translating node 16d will be transmitting OOB data 54 to the destination translating node 16. The destination translating node 16 may then associate all subsequently-received OOB data 54 from translating node 16d with the OOB control information 52 in the setup message until the destination translating node 16 receives a termination message that translating node 16d transmits once translating node 16d completes transmission of OOB data 54 to the destination translating node 16. After receiving OOB data 54 and OOB control information 52, the destination translating node 16 may utilize particular techniques to process OOB data 54 and OOB control information to complete delivery of OOB data 54 to the intended destination, as described below with respect to FIG. 3.

FIG. 3 illustrates operation of a particular embodiment of a translating node 16 in translating OOB data 54 and OOB control information 52 received from OOB network 14 for transmission on in-band network 12d. In particular FIG. 3, illustrates operation of translating node 16b as translating node 16 functions as a destination translating node, receiving OOB traffic 50 from another translating node 16, referred to here generically as “source translating node 16.” As shown, translating node 16b includes address mapping unit 120, tagging unit 130, processor 100, and memory 110. Additionally, as noted above, translating node 16b couples to in-band network 12d through in-band interface module 140 and couples to OOB network 14 through OOB interface module 150.

In operation, translating node 16b receives OOB traffic 50 transmitted by or added to OOB network 14 by a source translating node 16, such as node 16d. OOB traffic 50 includes OOB data 54 destined for a particular in-band node 32 of in-band network 12d (or a client of such an in-band node 32), in this case in-band network 12b, and associated OOB control information 52 to be used to deliver OOB data 54 to its destination. Translating node 16b receives OOB traffic 50 through OOB interface module 150. OOB data 54 and the associated OOB control information 52 may be received concurrently or at different times with translating node 16b buffering or storing the earlier arriving information for use when the later arriving information is received.

As noted above, translating node 16b receives OOB data 54 on the OOB data channel and OOB control information 52 on the OOB control channel, which represents a different channel from the OOB data channel. In particular embodiments, OOB network 14 utilizes multiple wavelengths to transmit OOB traffic 50, and the OOB data channel and the OOB control channel represent distinct wavelengths utilized by OOB network 14. In alternative embodiments, OOB network 14 utilizes two or more fibers to transmit OOB traffic 50. In such embodiments, OOB data channel and OOB control channel may represent separate fibers from among those utilized by OOB network 14. In the illustrated embodiment, the OOB data channel and the OOB control channel represent separate wavelengths, λ_{D} and λ_{C}, used for the transmission of OOB data 54 and OOB control information 52, respectively.

Furthermore, in a particular embodiment, OOB interface module 150 may be configured to receive OOB data 54 by dropping OOB data 54 from the OOB data channel. Thus, OOB interface module 150 may transmit a copy of OOB data 54 to any appropriate components of translating node 16, such as tagging unit 130, while allowing the OOB data 54 to continue to downstream components on OOB network 14. Additionally, OOB interface module 150, address mapping unit 120, or another suitable component of translating node 16b may determine, based on the OOB control information 52 associated with OOB data 54, that OOB data 54 is destined for an in-band node 32 coupled to in-band network 12d (or a client associated with such a node 32). If translating node 16b determines that OOB data 54 is not destined for an in-band node 32 coupled to in-band network 12d, translating node 16b discards, or otherwise disposes of, the dropped copy of OOB data 54.

For example, in a particular embodiment, OOB interface module 150 receives OOB control information 52 from source translating node 16b that specifies a physical address identifying a destination device for the associated OOB data 54. OOB interface module 150 may forward this OOB control information 52 to address mapping unit 120, and address mapping unit 120 may determine whether the specified physical address identifies an in-band node 32 coupled to in-band network 12d (or a client associated with such node 32.). In particular embodiments, address mapping unit 120 may make this determination based on whether the physical address of the destination device is included in local address list 122. If address mapping unit 120 determines that OOB data 54 is not destined for an in-band node 32 located on in-band network 12b, address mapping unit 120 may discard the copy of OOB data 54.

If, however, address mapping unit 120, or another appropriate component of translating node 16b, determines that OOB data 54 is destined for an in-band node 32 coupled to in-band network 12b, address mapping unit 120 may transmit OOB control information 52 to tagging unit 130. Tagging unit 130 then generates in-band traffic 40 based on OOB control information 52 and OOB data 54. Tagging unit 130 may process either or both of OOB control information 52 and OOB data 54 in any appropriate manner to generate in-band traffic 40. For example, in a particular embodiment, OOB control information specifies a Layer-2 address for a destination device of OOB data 54, and tagging unit 130 may append, concatenate, or otherwise attach the Layer-2 address to OOB data 54 to create in-band traffic 40. Translating node 16 then transmits in-band traffic 40 to the destination device on in-band network 12b using in-band interface module 140. In a particular embodiment, translating node 16b adds in-band traffic 40 to traffic propagating on the shared channel through in-band interface module 140. A particular in-band node 32 to which the destination device is coupled may then drop in-band traffic 40 from the shared channel and deliver in-band traffic 40 to the appropriate destination device.

In addition to receiving OOB control information 52 and OOB data 54, translating node 16b may, as noted above, also receive remote address updates 138 on the OOB control channel. Remote address updates 138 may provide updated information regarding devices coupled to in-band networks 12 other than in-band network 12d. For example, remote address updates 138 may include Layer-2 addresses for devices added to or removed from in-band networks 12 and a node 16 associated with each such Layer-2 address. Address mapping unit 120 may update remote address list 124 based on remote address updates 138. In particular, address mapping unit 120 may store an address for the newly-added device and an associated translating node 16 in remote address list 124. Additionally, in embodiments of heterogeneous communication system 10 in which OOB nodes are coupled directly to OOB network 14, translating node 16 may also receive address updates providing updated information regarding devices coupled to OOB network 14 and update OOB address list 128 based on these remote address updates 138.

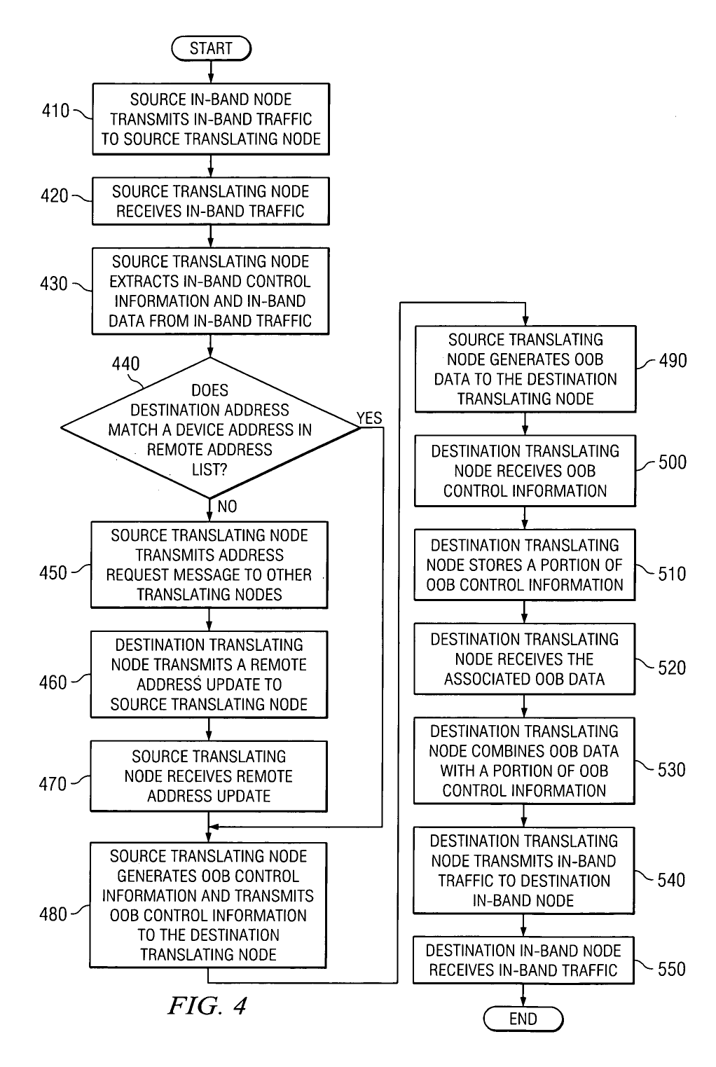

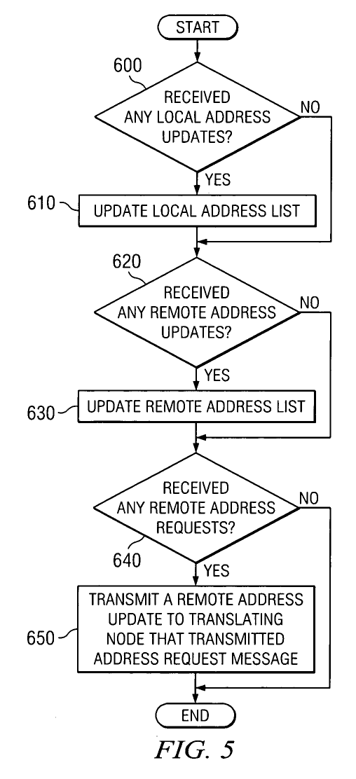

FIG. 4 is a flowchart illustrating an example operation of a particular embodiment of heterogeneous communication system 10. In particular, FIG. 4 illustrates an example operation of various elements of heterogeneous communication system 10 as a source in-band node 32 in a particular in-band network 12 communicates optical traffic to a destination in-band node 32 in another in-band network 12. As noted above, although FIG. 4 focuses on an embodiment of heterogeneous communication system 10 that supports communication in the form of optical traffic, particular embodiments of heterogeneous communication system 10 may be configured to support communication in any appropriate form.

At step 410, the source in-band node 32 transmits in-band traffic 40 to a source translating node 12 associated with the in-band network 32 in which that in-band node 32 is located. In-band traffic 40 includes in-band control information 42 and in-band data 44. In particular embodiments, the source in-band node 32 may transmit in-band traffic 40 in response to receiving electrical traffic from a client device coupled to the source in-band node 32. Additionally, in particular embodiments, the source in-band node 32 may transmit in-band traffic 40 to the source translating node 16 by adding in-band traffic 40 to optical traffic propagating on the optical ring 20 of that in-band network 12.

The source translating node 16 receives in-band traffic 40 at step 420. At step 430, the source translating node 16 extracts in-band control information 42 and in-band data 44 from in-band traffic 40. The source translating node 16 then attempts to identify, based on in-band control information 42 and remote address list 124 maintained by the source translating node 16, a destination translating node 16 associated with the destination in-band node 32 of in-band traffic 40. In particular, the source translating node 16 attempts to match a destination address in the in-band control information 42 with one of the device addresses located in remote address list 124 at step 440. If the destination address matches one of the device addresses in remote address list 124, the source translating node 16 determines that the destination translating node 16 is the translating node 16 associated with the matching device address in the remote address list 124, and operation continues at step 480.

If the source translating node 16 determines that the destination address does not match any of the device addresses in remote address list 124, the source translating node 16 transmits an address request message 136 that identifies the destination address to one or more other translating nodes 16 in heterogeneous communication system 10 at step 450. A particular translating node 16 that receives the address request message 136 may determine that it is the destination translating node 16. More specifically, a particular translating node 16 may determine based on its local address list 122 that it is coupled to the in-band network 12 that includes the destination in-band node 32. The destination translating node 16 may then transmit a remote address update 138 to the source translating node 16 that specifies an address for the destination translating node 16 at step 460. At step 470, the source translating node 16 receives the remote address update 138. The source translating node may then determine the destination translating node 16 based on the received remote address update 138.

At step 480, the source translating node 16 then generates OOB control information 52, based on in-band control information 42, and transmits OOB control information 52 to the destination translating node 16. At step 490, the source translating node 16 generates OOB data 54, based on in-band data 44, and transmits OOB data 54 to the destination translating node 16. The source translating node 16 may format and/or process in-band data 44 and in-band control information 42 in any appropriate manner to produce OOB data 54 and OOB control information, respectively.

At step 500, the destination translating node 16 receives OOB control information 52. The destination translating node 16 may store a portion of the OOB control information 52 at step 510. For example, OOB control information 52 may include the original in-band control information 42 and the destination translating node 16 may store that portion of OOB control information 52. At step 520, the destination translating node 16 receives the associated OOB data 54. As noted above, OOB control information 52 and OOB data 54 may be associated in any appropriate manner and the destination translating node 16 may use any suitable techniques to identify the OOB data 54 associated with OOB control information 52.

The destination translating node 16 may then combine OOB data 54 with a portion of the associated OOB control information 52 to form in-band traffic 40 at step 530. At step 540, the destination translating node 16 transmits the in-band traffic 40 to the destination in-band node 32. In particular embodiments, in-band traffic 40 transmitted by the destination translating node 16 may be identical to the in-band traffic received by the source translating node 16. Additionally, in particular embodiments, the destination translating node 16 may transmit in-band traffic 40 to the destination in-band node 32 by adding in-band traffic 40 to optical traffic already propagating on optical ring 20 of the relevant in-band network 12. At step 550, the destination in-band node 32 receives in-band traffic 40. In particular embodiments, the destination in-band node 32 may then convert in-band traffic to electrical signals for transmission to a particular client device coupled to the destination in-band node 32.

FIG. 5 is a flowchart illustrating operation of a particular embodiment of translating node 16. In particular embodiments of heterogeneous communication system 10, one or more translating nodes 16 may also be capable of maintaining and communicating addressing information utilized by translating nodes 16 or other elements of heterogeneous communication system 10. FIG. 5 illustrates example operation of a particular embodiment of translating node 16 in exchanging such addressing information.

At step 600, translating node 16 may determine whether or not translating node 16 has received any local address updates 134 from in-band nodes 32 in the in-band network 12 to which translating node 16 is coupled. If so, translating node 16 may update its local address list 122 to reflect the change indicated by the local address update 134 at step 610. Similarly, at step 620, translating node 16 may determine whether or not that translating node 16 has received any remote address updates 138 from other translating nodes 16. If so, translating node 16 may update its remote address list 124 to reflect the change indicated by the remote address update 138 at step 630. Translating node 16 may also determine whether it has received any address request messages 136 from other translating nodes 16 that specify a device address that matches on of the local addresses stored in the local address list 122 maintained by translating node 16 at step 640. If so, translating node 16 may, at step 650, transmit a remote address update 138 that specifies an address associated with translating node 16 to the translating node 16 that transmitted the address request message 136.

Thus, heterogeneous communication system 10 provides techniques for effectively managing end-to-end communication across a multiple heterogeneous communication networks. As a result, in particular embodiments of heterogeneous communication system 10, translating nodes 16 may be capable of replacing relatively expensive and less efficient Layer-3 routers that couple in-band networks and out-of-band networks. As a result, translating nodes 16 may offer a cost-effective solution for integrating heterogeneous communication systems. Additionally, because translating nodes 16 may be also capable of exchanging, across the various networks of heterogeneous communication system 10, address information associated with client devices that are in their in-band networks 12, heterogeneous communication system 10 may provide a flexible, robust communication system that can be easily scaled to address increased demand for communication services. Consequently, particular embodiments of heterogeneous communication system 10 and/or various components of heterogeneous communication system 10 may provide a number of benefits.

Although the present invention has been described with several embodiments, various changes and modifications may be suggested to one skilled in the art. It is intended that the present invention encompass such changes and modifications as fall within the scope of the appended claims.

What is claimed

1. A communication system, comprising:
one or more in-band networks, each operable to communicate data generated by a plurality of devices coupled to that in-band network, wherein the data is communicated in a channel and routed based on a destination address specified by in-band control information that is also communicated on the same channel as the data;
an out-of-band (OOB) network operable to communicate data between a plurality of translating nodes based on OOB control information that is associated with the data and that is communicated on an OOB control channel, wherein the OBB control channel comprises a different channel from a data channel on which the data is transmitted;
a first translating node, the first translating node coupling the OOB network and a first in-band network and operable to:
receive data and control information from the in-band network coupled to the first translating node;
identify, based on the control information, a second translating node associated with the destination address of the data, the second translating node coupling the OOB network and a second in-band network with which the destination address is associated;
transmit the control information to the second translating node in the control channel of the OOB network; and
transmit the data to the second translating node on the data channel of the OOB network; and
a second translating node, the second translating node coupling the OOB network and a second in-band network and operable to:
receive the control information from the first translating node on the OOB control channel of the OOB network;
receive the data from the first translating on the data channel of the OOB network;
determine based on the control information that the data is destined for a device coupled to the second in-band network;
combine the data and at least a portion of the control information; and
transmit the combined data and control information to the destination in the second in-band network.

2. The communication system of claim 1, wherein the control information comprises a Layer-2 address associated with a destination of the first data.

3. The communication system of claim 1, wherein the second translating node is operable to combine the data and at least a portion of the control information by appending at least a portion of the control information to the first data.

4. The communication system of claim 1, wherein the second translating node comprises a local address list that identifies addresses for devices on the second in-band network, and wherein the second translating node is operable to determine based on the control information and the local address list that the data is destined for a destination on the second in-band network.

5. The communication system of claim 1, wherein the first translating node comprises a remote address list that includes a plurality of remote address pairs, each remote address pair comprising an address for a device coupled to an in-band network other than the first in-band network and an address for a translating node associated with that device; and wherein the first translating node is operable to identify the second translating node based on the remote address list.

6. The communication system of claim 5, wherein:
the second translating node is further operable to transmit an address update to the first translating node on the control channel of the OOB network, wherein the address update comprises an address for a device coupled to the second network, and
in response to receiving the address update, the first translating node is operable to add a remote address pair to the remote address list, wherein the added remote address pair includes the address for the device coupled to the second network and an address of the second translating node.

7. The communication system of claim 5, wherein the first translating node is operable to identify the second translating node by:
determining that the destination address is not included in the remote address list;
in response to determining that the destination address is not included in the remote address list, transmitting an address request message to a plurality of translating nodes, each translating node coupling the OOB network and an in-band network, wherein the address update specifies the destination address; and
identify the second translating node based on an address update received from the second translating node; and wherein the second translating node is further operable to:
receive the address request message;
determine that the destination address is included in the local address list of the second translating node; and
in response to determining that the destination address is included in the local address list of the second translating node, transmit the address update to the first translating node, wherein the address update specifies an address of the second translating node.

8. A translating device comprising:
an in-band interface module operable to receive and transmit data and control information in a shared channel of an in-band network;
an out-of-band (OOB) interface module operable to:
receive and transmit data in a data channel of an OOB network; and
receive and transmit control information in a control channel of the OOB network;
an address mapping unit operable to:
identify, based on first control information received in the shared channel of the in-band network, another translating device associated with a destination device of first data receive in the shared channel of the in-band network; and
determine that second data received in the data channel of the OOB network is destined for a destination located in the in-band network based on second control information associated with the second data and received in the control channel of the OOB network; and
a tagging module operable to separate the first data and the first control information and to combine the second data and at least a portion of the second control information.

9. The translating device of claim 8, wherein the first control information comprises a Layer-2 address associated with a destination of the first data.

10. The translating device of claim 8, wherein the tagging module is operable to combine the second data and the second control information by appending the second control information to the second data.

11. The translating device of claim 8, wherein the address mapping unit comprises a local address list that identifies addresses for devices on the in-band network, and wherein the address mapping unit is operable to determine, based on the second control information and the local address list that the second data is destined for a destination on the in-band network.

12. The translating device of claim 11, wherein the OOB network module is further operable to receive an address request message transmitted by another translating device, wherein the address request message specifies an address, and wherein the address mapping unit is further operable to:
determine that the address is included in the local address list; and
in response to determining that the destination address is included in the local address list of the second translating node, cause the OOB network module to transmit an address update to the other translating node, wherein the address update specifies an address of this translating device.

13. The translating device of claim 8, wherein the address mapping unit comprises a remote address list that includes a plurality of remote address pairs, wherein each remote address pair includes an address for a device coupled to an in-band network and an address for a translating node associated with that in-band network; and wherein the address mapping unit is operable to identify the translating device associated with the destination device of the first data based on the remote address list and the first control information.

14. The translating device of claim 13, wherein the OOB interface module is further operable to receive an address update from another translating device in the control channel of the OOB network, wherein the address update comprises an address for a device coupled to the second network; and wherein the address mapping unit is operable to add a remote address pair to the remote address list, wherein the added remote address pair includes the address for the device coupled to the second network and an address of the second translating node.

15. The translating device of claim 14, wherein the address mapping unit is operable to identify the translating node associated with the destination device of the first data by:
determining that the destination address is not included in the remote address list;
in response to determining that the destination address is not included in the remote address list, causing the OOB interface module to transmit an address request message to a plurality of translating nodes, each translating node coupling the OOB network and an in-band network, wherein the address update specifies the destination address; and
identify the second translating node based on an address update received by the OOB interface module from the second translating node.

16. A method for providing communication service in a heterogeneous communication system that includes an out-of-band (OOB) network in which data is transmitted in a data channel and control information is communicated on a control channel, and a plurality of in-band networks in which data and control information is transmitted in a shared channel, wherein each of the in-band networks is coupled to the OOB network through one of a plurality of translating nodes, the method comprising:
receiving, at a first translating node, data and control information from a first in-band network coupled to the first translating node, wherein the data and the control information are received in a shared channel of the first in-band network;
identifying a second translating node associated with a destination address of the data based on the first control information, the second translating node coupling the OOB network and a second in-band network with which the destination address is associated;
transmitting the control information to the second translating node in the control channel of the OOB network;
transmitting the data to the second translating node on the data channel of the OOB network;
receiving, at the second translating node, the control information in the control channel of the OOB network;
receiving, at the second translating node, the data from in the data channel of the OOB network;
determining based on the control information that the data is destined for a device coupled to the second in-band network;
combining the data and at least a portion of the control information at the second translating node; and
transmitting the combined data and control information to a destination in the second in-band network.

17. The method of claim 16, wherein the control information comprises a Layer-2 address associated with the destination of the data.

18. The method of claim 16, wherein combining the data and at least a portion of the control information comprises appending a portion of the control information to the data;

19. The method of claim 16, wherein determining that the data is destined for a device coupled to the second in-band network comprises determining based on the control information and a local address list that the data is destined for a device coupled to the second in-band network, wherein the local address list is stored by the second translating node and identifies addresses for devices on the second in-band network.

20. The method of claim 16, wherein identifying the second translating node comprises identifying the second translating node based on a remote address list, wherein the remote address list is stored by the first translating node and includes a plurality of remote address pairs, each remote address pair including an address for a device coupled to an in-band network other than the first in-band network and an address for a translating node associated with that device.

21. The method of claim 20, further comprising:
transmitting an address update from the second translating node to the first translating node on the control channel of the OOB network, wherein the address update comprises an address for a device coupled to the second network; and
adding a remote address pair to the remote address list, in response to the first translating node receiving the address update, wherein the added remote address pair includes the address for the device coupled to the second network and an address of the second translating node.

22. The method of claim 20, wherein identifying the second translating node comprises:
determining that the destination address is not included in the remote address list;
in response to determining that the destination address is not included in the remote address list, transmitting an address request message from the first translating node to a plurality of translating nodes that each couple the OOB network to an in-band network, wherein the address update specifies the destination address;
receiving the address request message at the second translating node;
determining the destination address is included in a local address list stored by the second translating node, wherein the local address list identifies addresses for devices on the second in-band network;
transmitting an address update from the second translating node to the first translating node, wherein the address update specifies an address of the second translating node; and
identifying the second translating node based on the address update.
